(19) United States
(12) Patent Application Publication
(10) Pub. No.: US 2022/0253688 A1
(43) Pub. Date: Aug. 11, 2022

(54) RECOMMENDATION SYSTEM WITH ADAPTIVE WEIGHTED BAYSIAN PERSONALIZED RANKING LOSS

(71) Applicants: Haolun WU, Montreal (CA); Chen MA, Montreal (CA); Yingxue ZHANG, Montreal (CA)

(72) Inventors: Haolun WU, Montreal (CA); Chen MA, Montreal (CA); Yingxue ZHANG, Montreal (CA)

(21) Appl. No.: 17/170,865

(22) Filed: Feb. 8, 2021

(51) Int. Cl. G06N 3/08; G06Q 30/06; G06N 3/04; G06F 16/215

(52) U.S. Cl. CPC G06N 3/08; G06F 16/215; G06N 3/0454; G06Q 30/0631

(57) ABSTRACT

Recommendation system for processing an input dataset that identifies a set of users, a set of items, and user-item interaction data. A plurality of unique triplets are identified based on the input dataset, wherein each triplet includes: a positive user-item pair; and a negative user-item pair. Over a plurality of training iterations system parameters are learned, including (i) a set of model embeddings for generating respective user-item relevance scores for the positive user-item pairs and the negative user-item pairs; and (ii) weight parameters for each of the triplets. The learning is configured to jointly optimize the model embeddings and the weight parameters to reach a learning objective that is based on weighted difference values determined for the triplets.

### RELATED APPLICATIONS

None

### FIELD

This disclosure relates generally to the processing of data using machine learning techniques, particularly in the context of recommendation systems.

### BACKGROUND

An information filtering system is a system that removes redundant or unwanted information from an information stream that is provided to a human user in order to manage information overload. A recommendation system (RS) is a subclass of an information filtering system that seeks to predict the rating or preference a user would give to an item. RSs are often used in commercial applications to guide users to find their true interests out of a substantial number of potential candidates.

Personalized ranking RSs play an important role in many online services. The task of personalized ranking is to provide a ranked list of items for each individual user. Accurate personalized ranking RSs can benefit users as well as content publishers and platform providers. RSs are utilized in a variety of commercial areas to provide personalized ranked list recommendations to users, including for example: providing video or music suggestions for streaming and download content provider platforms; providing product suggestions for online retailer platforms; providing application suggestions for app store platforms; providing content suggestions for social media platforms; and suggesting news articles for mobile news applications or online news websites.

RSs usually employ one or both of collaborative filtering (CF) and content-based filtering. Both of these filtering methodologies apply a personality-based approach that recommends personalized products or services for different users based on their historical behaviors.

CF methodologies typically build a predictive model or function that is based on a target or active user's past behavior (e.g., items previously purchased or selected and/or a numerical rating given to those items) as well on the past behavior of other users who have behavioral histories similar to that of the active user. By contrast, content-based filtering methodologies utilize a series of discrete, pre-tagged characteristics of an item (item attributes) in order to recommend additional items with similar properties. However, content-based filtering methodologies can be impeded by the fact that a large number of items have a very limited number of associated item attributes, due at least in part to the volume of items that are continually being added.

Some RSs integrate content-based filtering methodologies into CF methodologies to create a hybrid system. However, the lack of suitable item attributes for the exploding number of items that are available through online platforms requires most RSs to still heavily rely on only CF methods that give recommendations based on users' historical behaviors.

CF methodologies can typically be summarized as: Step 1) Look for users who share the same interaction patterns with the active user (the user whom the prediction is to be made); and Step 2) Use the ratings/interactions from those like-minded users found in step 1 to calculate a prediction for the active user. Finding users who share the same interaction patterns requires identification of similar users or similar items. The process of deriving similar users and similar items includes embedding each user and each item into a low-dimensional space created such that similar users are nearby and similar items are nearby. In this regard, an embedding is a mapping of discrete, categorical, variables to a vector of continuous numbers. In the context of neural networks, embeddings are low-dimensional, learned continuous vector representations of discrete variables. Embeddings in personalized RS are useful because they can meaningfully represent users and items in a transformed vector space as low-dimensional vectors.

Existing CF approaches attempt to generate representative and distinct embeddings for each user and item. Such representative embeddings can capture complex relations between users and items. The closer that an item and a user are in a vector space, the more likely that the user will interact with or rate the item highly.

A classic and successful method for CF is matrix factorization (MF). MF algorithms characterize both items and users by vectors in the same space, inferred from observed entries of user-item historical interaction. MF algorithms work by decomposing a user-item interaction matrix into the product of two lower dimensionality rectangular matrices with the goal of representing users and items in a lower dimensional latent space (also known as embedding representation in the context of deep learning algorithms). Early work in MF mainly applied the mathematical discipline of linear algebra of matrix decomposition, such as SVD (singular value decomposition³) and its variants. In recent years, artificial neural network (ANN) and deep-learning (DL) techniques have been proposed, some of which generalize traditional MF algorithms via a non-linear neural architecture parameterized by neural networks and learnable weights. In the case of both linear algebra and DL-based MF models, the goal of MF is to find the right representation of each user and each item as vector representations.

In RS, various relationships exist that can be represented as datasets that take the form of graphs or matrices. For example, a social network can be modeled by a user-user graph or matrix, commodity similarity can be modeled by an item-item graph or matrix, and user-item interaction can be modeled by a user-item bipartite graph or matrix. Graph convolution neural networks (GCNNs) have demonstrated to be powerful tools for learning embeddings. GCNNs have been applied for recommendation by modeling the user-item interaction history as a bipartite graph. GCNNs are trained to learn user and item representations of user and item nodes in a graph structure and model user-item interaction history as connecting edges between the nodes. The vector representation of a node is learned by iteratively combining the embedding (i.e., mapping of a discrete variable to a vector of continuous numbers) of the node itself with the embeddings of the nodes in its local neighborhood. In the context of neural networks, embeddings are low-dimensional, learned continuous vector representations of discrete variables. Neural network embeddings are useful because they can reduce the dimensionality of categorical variables and meaningfully represent categories in the transformed space.

Most existing methods split the process of learning a vector representation (i.e., embedding) of a node (which can be an item node or a user node) into two steps: neighborhood aggregation, in which an aggregation function operates over sets of vectors to aggregate the embeddings of neighbors, and center-neighbor combination that combines the aggregated neighborhood vector with the central node embedding. GCNN-based CF models learn user and item node embeddings on graphs in a convolution manner by representing a node as a function of its surrounding neighborhood.

In some GCNN based bipartite graph RSs, the aggregation function operates over local neighborhoods of a central node (e.g., an item node or a user node), where a local neighborhood refers to the direct connection of that node in the given topology (graph). For example, the item nodes that interact with a central user node will form the local neighborhood of that user node. In the case of an ANN, the aggregation function can be implemented using an NN Multi-layer perception (MLP) that transforms the input using a learnable non-linear transformation function to learn weights on every single dimension of the input vector. The output of the MLP layer is the input vector weighted by neural network parameters, and these parameters will be updated by gradient descent of the neural network.

The usual approach for personalized ranking is to predict a personalized score ŷᵤᵥ for an item v that reflects the preference of the user u for the item. Then the items are ranked by sorting them according to that score.

Existing RSs treat an observed user-item interaction dataset as a ground-truth depiction of relationships and thus treat the observed dataset as very strong prior knowledge. However, because of data sparsity, user-item interaction datasets often contain information about a limited number of observed user-item interactions. This problem of data sparsity is illustrated in FIG. 1, which represents an observed user-item interaction dataset as a user-item interaction matrix 102 where “+” denotes that a user has observed a respective item of a user-item pair. For example, a “+” at the intersection of a user row with an item column can indicate the user has previously interacted with the respective item by “clicking” on the item, ranking the item, downloading the item, purchased the item, or otherwise indicated an interest in the item. The symbol “?” at the intersection of a user row with an item column indicates that the user has not observed the respective item.

A relationship between user and item can be implied as positive or negative based on whether a user has observed an item or not. User-item interaction matrix 104 represents the sparse observed data of matrix 102 that defines a set of implicit relationships between users and items. Items that a user has observed are implicitly designated as “negative” items with respect to that user, and these negative user-item pairs are designated by “0”s in user-item interaction matrix 104. Items that a user has observed are implicitly designated as “positive” items with respect to that user, and these positive user-item pairs are designated by “1”s in user-item interaction matrix 104.

One RS employs Bayesian Personalized Ranking (BPR) (see: [Stephen Rendle, Christoph Freudenthaler, Zeno Gantner and Lars Schmidt-Thieme, “BPR: Bayesian Personalized Ranking from Implicit Feedback”; UAI 2009, pp. 452 to 461]), that trains a prediction model that treats the input training dataset as a set of of data triplets, with each triplet including a user, an item that is a positive item with respect to that user, and an item that is a negative item with respect to that user. The training objective of such a RS that employs BPR (hereinafter a BPR RS) is to optimize correct rankings of the user-item pairs within each triplet instead of scoring user-item rankings individually. A basic assumption of the BPR RS is that the user will prefer any positive item over all other negative items.

However, a limitation of existing BPR RSs is that they treat all triplets equally during training. This can lead to sub-optimal rankings as some triplets may be more important than other triplets when training for an optimal solution. For example, some triplets may include one or more user-item pairs for which the implied positive or negative designation is inaccurate, however these inaccurate triplets are treated the same as more accurate triplets during training.

Accordingly there is a need for personalized ranking BPR RS that is able to compensate for data sparsity and inaccurate relationship assumptions that are inherently present in an environment of rapidly expanding numbers of users and volume of content.

### SUMMARY

According to a first aspect, a computer implemented method is disclosed for a recommendation system for processing an input dataset that identifies a set of users, a set of items, and user-item interaction data. The computer implemented method includes: identifying a plurality of unique triplets based on the input dataset, wherein each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item. The method further includes learning, over a plurality of training iterations, (i) a set of model embeddings for generating respective user-item relevance scores for the positive user-item pairs and the negative user-item pairs; and (ii) weight parameters for each of the triplets, wherein the learning is configured to jointly optimize the model embeddings and the weight parameters to reach a learning objective that is based on weighted difference values determined for the triplets, wherein for each triplet, the difference value is a difference between the user-item relevance score generated for the positive user-item pair thereof and the user-item relevance score generated for the negative user-item pair thereof. A list of one or more recommended items is then generated for each user based on a set of user-item relevance scores generated using the learned set of model embeddings.

The learning of weight parameters for each of the triples in combination with model embeddings may, in some applications, enable more accurate personalized rankings to be generated by an RS, and also allow the RS to be trained quicker. This may enable operation of an RS to be optimized such that a user is not presented with irrelevant or misleading item options. In least some aspects of the computer-implemented method of the present disclosure, optimization can improve RS efficiency as the consumption of one or more of computing resources, communications bandwidth and power may be reduced by not presenting users with irrelevant options and minimizing exploration of irrelevant options by users.

In accordance with the computer-implemented method of the first aspect, for each triplet, the indication in the user-item interaction data that the second item is less relevant to the user than the first item may include a first indication that the first item has been observed by the user and a second indication that the second item has not been observed by the user.

In accordance with the computer-implemented method of the first aspect, the weight parameters may include a respective weight value for each triplet, and the learning objective is to maximize a sum of the weighted difference values determined for the triplets, wherein each difference value is weighted by the respective weight value for the triplet that the difference value is determined in respect of.

In accordance with the computer-implemented method of the first aspect, learning the set of model embeddings and the weight parameters may include performing a bilevel optimization process that includes an inner optimization stage for learning the model embeddings based on a lower-level objective function and an outer optimization stage for learning the weight parameters based on an upper level objective function.

In accordance with the computer-implemented method of the first aspect, performing the bilevel optimization process may include computing proxy embeddings for the model embeddings and using the proxy embeddings during the outer optimization stage.

In accordance with the computer-implemented method of the first aspect, the inner optimization stage for learning the model embeddings may include: (a) generating the respective weight values for each of the triplets based on the weight parameters; (b) generating a set of final user embeddings and final item embeddings based on the model embeddings, wherein the model embeddings include representative user model vectors for each of the users in the set of users and representative item model vectors for each of the items in the set of items; (c) generating the respective user-item relevance scores for the positive user-item pairs and the negative user-item pairs based on the final user embeddings and the final item embeddings; (d) determining the difference values for the triplets based on the generated relevance scores; (e) determining the sum of the weighted difference values for the triplets comprising: determining, for each triplet, the product of the difference value and the weight value for the triplet; and summing the products; (f) updating the model embeddings by a model embeddings gradient based on the sum of the weighted difference values; (g) repeating (b to f) until the model embeddings are optimized with respect to the weight parameters. The outer optimization stage for learning the weight parameters comprises: (h) determining a proxy set of model embeddings; (i) generating a set of final user embeddings and final item embeddings based on the proxy set of model embeddings; (j) generating the respective user-item relevance scores for the positive user-item pairs and the negative user-item pairs based on the final user embeddings and the final item embeddings; (k) determining the difference values for the triplets based on the generated relevance scores; (l) determining the sum of the weighted difference values for the triplets comprising: determining, for each triplet, the products of the difference value and the weight value for the triplet; and summing the products; (m) updating the weight parameters by a weight parameter gradient based on the sum of the weighted difference values; (n) generating an updated set of the weight values for the triplets based on the updated weight parameters; and (o) repeating (l to n) until the weight parameters are optimized with respect to the proxy set of model embeddings.

In accordance with the computer-implemented method of the first aspect, the method may include generating the respective relevance scores during each of the training iterations by: generating, based on the user-item interaction data, a user-user similarity dataset that indicates user-user similarity scores for pairs of users in the set of users; generating, based on the user-item interaction data, an item-item similarity dataset that indicates item-item similarity scores for pairs of items in the set of items; determining final user embeddings based on the user-user similarity dataset and a set of personalized user embeddings included in the model embeddings; determining final item embeddings based on the item-item similarity dataset and a set of personalized item embeddings included in the model embeddings; determining the user-item relevance scores based on the final user embeddings and the final item embeddings.

In accordance with the computer-implemented method of the first aspect, the set of model embeddings may configure a first artificial network and the weight parameters may configure a second artificial neural network.

According to a second aspect, a non-volatile computer readable medium is disclosed that stores software instructions that, when executed by a processing device, cause the processing device to perform the computer implemented method of the first aspect.

According to further aspect, a recommendation system is disclosed for processing an input dataset that identifies a set of users, a set of items, and user-item interaction data about historic interactions between users in the set of users and items in the set of items. The recommendation system includes a processing device; and a non-transient storage coupled to the processing device and storing software instructions that when executed by the processing device configure the recommendation system to: identify a plurality of unique triplets based on the input dataset, wherein each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item; learn, over a plurality of training iterations, (i) a set of model embeddings for generating respective user-item relevance scores for the positive user-item pairs and the negative user-item pairs; and (ii) weight parameters for each of the triplets, wherein the model embeddings and the weight parameters are jointly learned to reach a learning objective that is based on weighted difference values determined for the triplets, wherein for each triplet, the difference value is a difference between the user-item relevance score generated for the positive user-item pair thereof and the user-item relevance score generated for the negative user-item pair thereof; and generate a list of one or more recommended items for each user based on a set of user-item relevance scores generated using the learned set of model embeddings.

### BRIEF DESCRIPTION OF THE DRAWINGS

Reference will now be made, by way of example, to the accompanying drawings which show example embodiments of the present application, and in which:

FIG. 1 is a block diagram illustrating an example of a matrix representation of a user-item interaction dataset;

FIG. 2 is a block diagram illustrating a recommendation system according to example embodiments;

FIG. 3 is a block diagram illustrating examples of a User-Item (U-I) interaction matrix, User-User (U-U) similarity matrix and Item-Item (I-I) similarity matrix according to example embodiments;

FIG. 4 is a pseudocode representation of training process for the RS of FIG. 2; and

FIG. 5 is a flowchart showing actions performed by the RS of FIG. 2 according to an example embodiment; and

FIG. 6 is a block diagram illustrating an example processing system that may be used to execute machine readable instructions to implement the RS of FIG. 2.

Similar reference numerals may have been used in different figures to denote similar components.

### DESCRIPTION OF EXAMPLE EMBODIMENTS

A machine learning (ML) based recommendation system (RS) is described that employs Bayesian Personalized Ranking (BPR) that is configured to distinguish between different user, positive item, negative item triplets during training. The BPR RS uses bilevel optimization during training to jointly learn parameters for a weight generator for the triplets as well as model parameters for an item-user relevance prediction model.

Bilevel optimization can be considered as an optimization problem that contains another optimization problem as a constraint, for example an outer optimization task (commonly referred to as the upper-level optimization task), and an inner optimization task (commonly referred to as the lower-level optimization task). Bilevel optimization can be implemented using a computer program to model hierarchical decision processes and engineering design problems. A simple form of the bilevel optimization problem is defined below:

$${min}_{x ∈ X , y} F ( x , y ) \\ s . t . G ( x , y ) \leq 0 \\ {min}_{y} f ( x , y ) \\ s . t . g ( x , y ) \leq 0 ,$$

Where x and y are a set of upper-level variables and lower-level variables respectively. Similarly, the functions F and ƒ are upper-level and lower-level objective functions respectively, while the vector-valued functions G and g are called the upper-level and lower-level constraints respectively. Upper-level constraints G involve variables from both levels and play a very specific role. The application of bilevel optimization in an RS will be discussed in greater detail below.

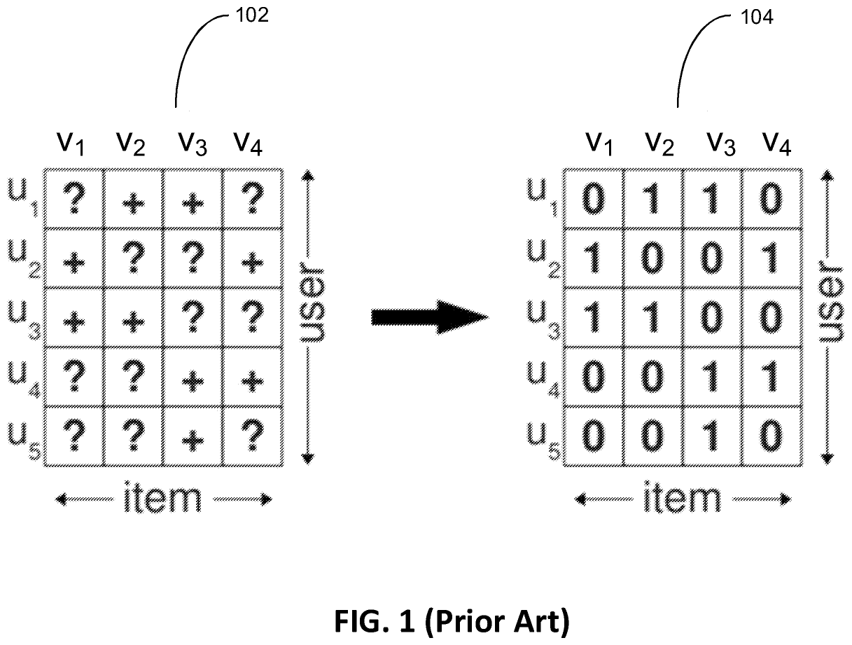

As known in the art, a graph is a data structure that comprises nodes and edges. Each node represents an instance or data point. Each edge represents a relationship that connects two nodes. A bipartite graph is a form of graph structure in which each node belongs to one of two different node types and direct relationships (e.g., 1-hop neighbors) only exist between nodes of different types. A bipartite graph can be used to represent or model a dataset of user-item interactions, and can be expressed as a user-item interaction matrix. Previously mentioned FIG. 1 illustrates a simplified representation of user-item interaction matrices 102 and 104 that model an observed user-item dataset that corresponds to a bipartite graph that includes user type nodes and item type nodes. User type nodes (referred to herein as user nodes) represent users u₁ to u₄ (collectively user set U, representing a set of nᵤₛₑᵣₛ=4 users) and item type nodes (referred to herein as item nodes) that represent items v₁ to v4 (collectively item set I, representing a set of nᵢₜₑₘₛ=4). In the present disclosure, “u” is used to refer to a generic user or users and “v” is used to refer to a generic item or items. Each respective user node represents an instance of a user u (each user u is represented by a respective row in the matrices 102, 104 of FIG. 1). Each respective item node represents an instance of a unique item v (each item v is represented by a respective column in the matrices 102, 104 of FIG. 1). Items may for example be products or services that are available to a user. For example, in various scenarios, items may be: audio/video media items (such as a movie or series or video) that a user can stream or download from an online video content provider; audio media items (such as a song or a podcast) that a user can stream or download from an online audio content provider; image/text media items (such as new articles, magazine articles or advertisements) that a user can be provided with by an online content provider; software applications (e.g., online apps) that a user can download or access from an online software provider such as an app store; and different physical products (e.g., toys, prepared meals, clothing, etc.,) that a user can order for delivery or pickup from an online retailer. The examples of possible categories of items provided above is illustrative and not exhaustive. Users and items are each identified by respective identifiers (e.g., user ID and item ID)

Relationships between users u and items v are represented by the values included in the elements of the user-item matrices 102, 104. As noted above in example embodiments, relationship pairs denoted by a “+” in user-item matrix 102 indicates that the user has observed the item in the pair, and such interaction is implicitly deemed to denote a positive relationship, represented as a “1” in user-item matrix 104. Relationship pairs denoted by a “?” in user-item matrix 102 indicate the user has not observed the item in the pair, and the lack interaction is implicitly assumed to denote a negative relationship, represented “0” in user-item matrix 104. User-item pairs denoted by a “1” can be considered positive user-item pairs, and user item pairs denoted by a “0” can be assumed to be negative user-item pairs.

Issues can arise when training a BPR RS due to the data sparsity from the lack of user-item interactions as well as from the implicit feedback that is assumed from both observed and unobserved items. These issues include: (i) False positives in implicit feedbacks. In implicit datasets, if a user accidently clicks an item, then that item will be regarded as a positive item with respect to that user, providing an incorrect indication of that user's preference. (ii) False negative in implicit feedbacks. There can two reasons why a user interaction with an item has not been observed: (1) true negative: the user actually has no interest in an item, so has purposefully ignored it, or (2) false negative: the user has not yet had the opportunity to interact with the item, but he/she may actually prefer it. Existing solutions may not effectively distinguish between true negatives and false negatives.

In order to address these problems, an adaptive BPR RS is disclosed that is configured to distinguish between user, positive item, negative item triplets when training of the BPR RS. In example embodiments, triplet-wise unique weights are used to distinguish between the relative importance of different triplets during training. Bilevel optimization is used during training of the BPR RS so that the triplet-wise weights can be optimized adaptively along with model parameters for an item-user relevance prediction model that is used to predict user-item relevance scores.

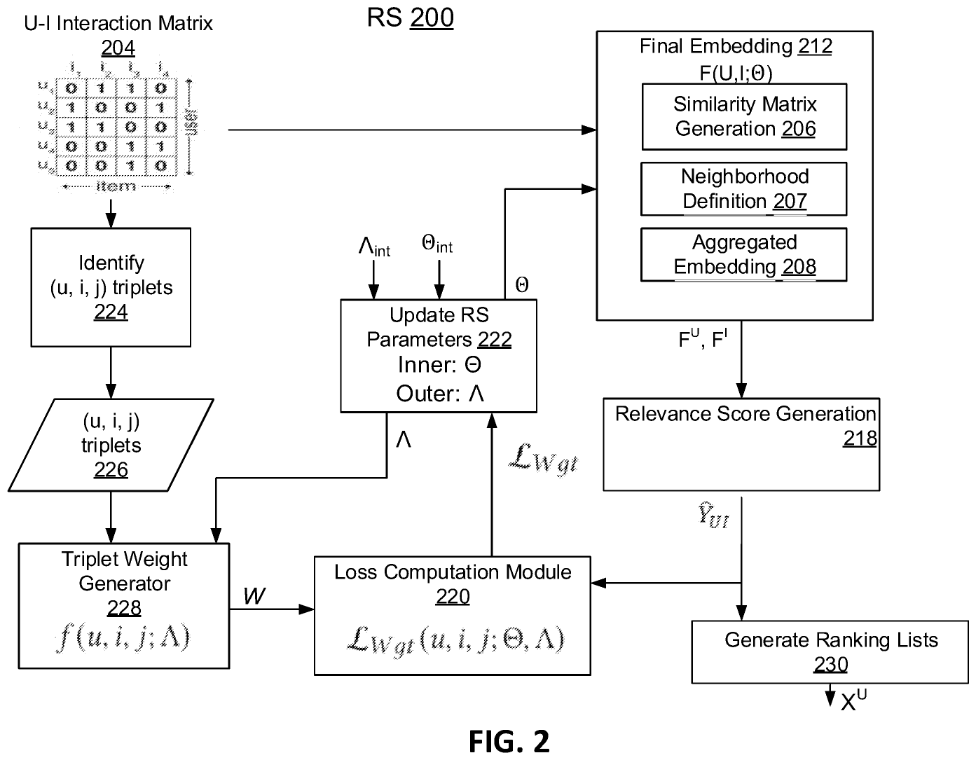

In this regard, FIG. 2 is a block diagram of an BRP RS 200 according to example embodiments. BPR RS 200 (hereinafter RS 200) is configured to perform a plurality of operations using one or more modules (for example, modules represented by blocks labelled 212, 218, 220, 222, 228 and 230 in FIG. 2) that enable the system to perform as described. As used here, a module can refer to a combination of a hardware processing circuit and machine-readable instructions (software and/or firmware) executable on the hardware processing circuit to perform one or more given operations. A hardware processing circuit can include any or some combination of a microprocessor, a core of a multi-core microprocessor, a microcontroller, a programmable integrated circuit, a programmable gate array, a digital signal processor, or another hardware processing circuit. In some examples, a “module” can refer to a task or function that is performed by a hardware processing circuit that is specifically configured to perform one or more given operations.

Although the RS 200 shown in FIG. 2 includes “modules”, it will be appreciated that in other embodiments, the RS 200 may performs various operations to train RS 200 to learn a plurality of model parameters for an item-user relevance prediction model in respect of an input U-I interaction dataset, and then predict, using the trained item-user relevance prediction model RS 200 (i.e. the item-user relevance prediction model with learned model parameters), personalized item rankings for users. As used herein, an “operation” can refer to a task or function performed by machine-readable instructions (software and/or firmware) when executed by a hardware processing circuit.

The overall recommendation task that is performed by RS 200 is treated as a ranking problem in which the input is user implicit feedback included in a user-item (U-I) interaction dataset and the final output is an ordered set of recommended items Xᵤ with respect to each user u. A U-I interaction dataset can be provided as input to RS 200 in the form of a nᵤₛₑᵣ×nᵢₜₑₘ, U-I interaction matrix 204. U-I interaction matrix is provided as input to a machine learning (ML) based final embedding module 212 that applies a learned function F(U,I; Θ) to generate a set of user final embeddings F^{U} and item final embeddings F^{I} for the users and items included in U-I interaction matrix 204 based on a set of personalized user embeddings Θ^{U} for users in the user set U and a set of personalized item embeddings Θ^{I} for items in the item set I. Each user u is modeled as a respective, representative d dimensional vector θᵤ in the set of personalized user embeddings Θ^{U}. Similarly, each item v is modeled as a respective, representative d dimensional vector θᵥ in the set of personalized item embeddings θ^{I}. The set of user embeddings Θ^{U} and item embeddings Θ^{I} can be collectively denoted as model embeddings Θ∈ [symbol] [symbol] , where d is the dimensionality of each representative vector (non-limiting examples of possible values for d include 50 or 64). As will be explained in greater detail below, the sets of personalized user embeddings Θ^{U} and item embeddings Θ^{I} are adaptively learned over a set of training iterations, such that a respective, unique representative vector is learned for each user u and item v. Prior to training the RS 200, initialized model embeddings Θᵢₙᵢₜ can be generated by random sampling from a range or pre-defined distribution of candidate embedding values.

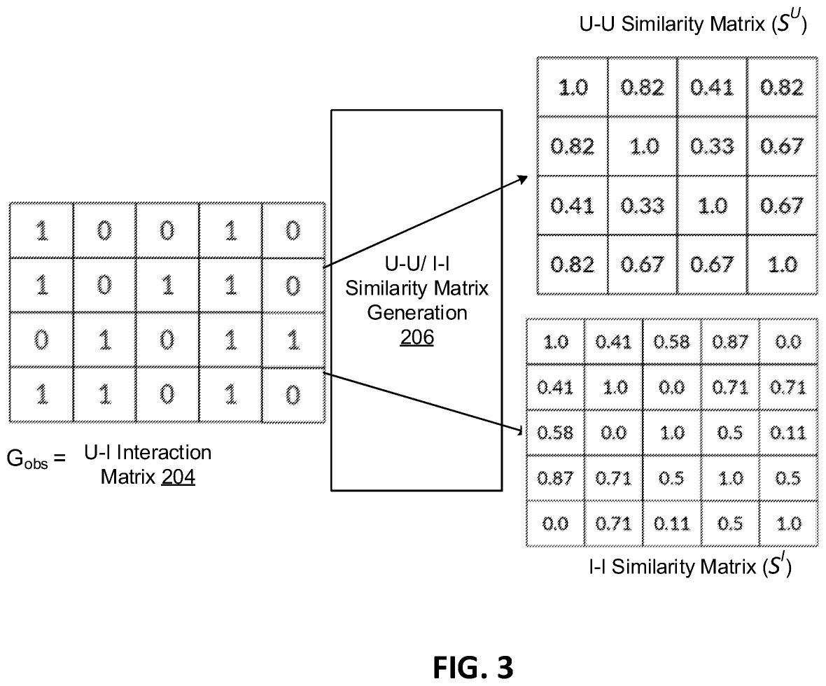

Final embedding module 212 can be implemented using a number of different possible configurations. By way of non-limiting example, in one possible RS configuration, final embedding module 212 includes, with reference to FIG. 3, a similarity matrix generation module 206 for generating an nᵤₛₑᵣ×nᵤₛₑᵣ User-User (U-U) similarity matrix (S^{U}) and an nᵢₜₑₘ×nᵢₜₑₘ Item-Item (I-I) similarity matrix (S^{I}) in respect of U-I interaction matrix 204. In User-User (U-U) similarity matrix (S^{U}), the row corresponding to a user u incudes a vector of respective similarity scores that each indicate a respective similarity between the user u and each of the users included in user set U. In Item-Item (I-I) similarity matrix (S^{U}), the row corresponding to an item v incudes a vector of respective similarity scores that each indicate a respective similarity between the item v and each of the items included in item set I. In example embodiments, similarity matrix generation module 206 is configured to determine similarity scores for user pairs based on the number of common items that each user in the pair has observed. Similarity matrix generation module 206 is configured to determine similarity scores for item pairs based on the number of common users that each item in the pair has observed. Although different methods can be used to determine similarity scores, in an illustrated example, similarity matrix generation module 206 applies a cosine similarity algorithm to generate U-U similarity matrix (S^{U}) by row and I-I similarity matrix (S^{I}) 210 by column, and the similarity scores calculated for user pairs and item pairs are cosine similarity scores. In the illustrated example, each of the similarity scores is normalized within a range of 0 to 1, with 1 indicating greatest similarity.

Referring again to FIG. 2, in example embodiments, a neighborhood definition module 207 is applied to determine neighborhoods of similar users for each user and similar items for each item based on the user-user pair and item-item pair similarity scores included in U-U similarity matrix (S^{U}) and I-I similarity matrix (S^{I}) (for example top-k neighbors based on similarity scores). An aggregation module 208 is then applied to generate a neighborhood embedding n_u for each user u and a neighborhood embedding n_v for each item v based on the determined neighborhoods of similar users for each user and similar items for each item and the sets of user embeddings Θ^{U} and item embeddings Θ^{I}. In such examples, the final embeddings F^{U} and F^{I} can be the set that includes the generated neighborhood embeddings for the users u and the set that includes the generated neighborhood embedding for the items v, respectively.

In example embodiments, a relevance score generation module 218 is configured to generate a respective relevance score ŷᵤᵥ for each user-item pair included in the input U-I interaction matrix. In example embodiments, a U-I relevance score matrix Ŷ_{UV} can be generated as a dot product of the user final embeddings F^{U} and the item final embeddings F^{I}:

Ŷ_{UI}=(F^{U}·F^{I})

As will be explained in greater detail below, a training phase of RS 200 is performed (i.e., the RS is trained) until the system parameters (in example embodiments, system parameters include model embeddings Θ and, as will be described below, a set of weight generator parameters ∧ for a triplet weight generator module) have been adaptively learned to optimize a defined objective. When the training phase is complete and the defined objective optimized, a final set Ŷ_{UI} of relevance scores is generated by relevance score generation module 218 during an inference phase, and this final set of final set Ŷ_{UI} of relevance scores can be used by a generate ranking lists module 230 to generate a personalized recommendation list xᵤᵥ of items that are most relevant for each individual user u. In some examples, the inference phase may be a final iteration of the training phase.

Referring to FIG. 2, for training purposes the RS 200 includes a triplet identification module 224 for identifying a list of user, positive item, negative item triplets (u, i, j) 226 from the U-I interaction matrix 204, where “i” denotes an item v that is a positive item with respect to user u, and “j” denotes an item v that is a negative item with respect to user u. Accordingly, each triplet (u, i, j) identifies a positive user-item pair u,i where i is a positive item with respect to user u, and a further negative user-item pair u,j where a further item j is a negative item with respect to the same user u. An implied assumption for each triplet (u, i, j) is that the user u identified in (u, i, j) prefers item i over item j (e.g., item i is more relevant to the user u than item j) The identified (u, i, j) triplets are provided to an ML based triplet weight generator module 228 that applies a learned function ƒ(u, i, j; ∧) to generate as set of weights W that includes respective weight value w_{u,i,j} for each triplet (u, i, j). By way of example, learned function ƒ(u, i, j; ∧) may include an artificial neural network (ANN) that is configured by weight generator parameters ∧ that are learned during training of RS 200. Prior to the training phase, an initial set of weight generator parameters ∧ᵢₙₜ can be generated by random sampling from a range or pre-defined distribution of candidate parameter values.

RS 200 includes a loss computation module 220 that receives the following inputs during training: (i) information that identifies each triplet (u, i, j); (ii) a current set of triplet weights W; and (iii) U-I relevance score matrix Ŷ_{UV} generated using the current set of model embeddings Θ.

During the training phase, the relevance scores ŷᵤᵥ include in U-I relevance score matrix Ŷ_{UV} are separated by loss computation module 220, based on user and item identity, into relevance scores ŷᵤᵢ that correspond to user-item pairs in which the item is positive with respect to the user and relevance scores ŷᵤⱼ that correspond to user-item pairs in which the item is negative with respect to the user. During the training phase, the objective is joint optimization objective to learn: (i) model embeddings Θ that will maximize the difference between the relevance scores ŷᵤᵢ and ŷᵤⱼ that correspond to the user, positive item and negative item identified in a triplet (u, i, j) and triplet; and (ii) weight generator parameters ∧ that will maximize the importance of triplets (u, i, j) that include true positive and true negative user-item pairs and minimize the importance of triplets (u, i, j) that include false positive or false negative user-item pairs.

The joint objective of learning optimal model embeddings Θ and optimal weight generator parameters ∧ is treated as a bilevel optimization problem where the weight generator parameters ∧ is a set of upper-level (e.g., outer) variables and the model embeddings Θ and is a set of lower-level (e.g., inner) variables. The upper level and lower level objective functions can be respectively represented as:

$${min}_{Λ} {𝒥}_{outer} ( Θ * ( Λ ) ) := {\sum }_{u} {\sum }_{i ∈ {S}_{u}} {\sum }_{j ∉ {S}_{u}} {ℒ}_{Van} ( u , i , j ; Θ * ( Λ ) ) \\ s . t . Θ * ( Λ ) = {arg min}_{Θ} {𝒥}_{inner} ( Θ , Λ ) := {\sum }_{u} {\sum }_{i ∈ {S}_{u}} {\sum }_{j ∉ {S}_{u}} {ℒ}_{Wgt} ( u , i , j ; Θ , Λ )$$

### Where:

u: user

i: positive item

j: negative item

Sᵤ: training data for user u, contain all positive items

Θ∈

[symbol]

[symbol]

∧: parameter of the weight generator

The inner level loss can be denoted as:

[symbol]

w_{gt}(u,i,j;Θ,∧)=−ƒ(u,i,j;∧)·log σ(ŷᵤᵢ(Θ)−ŷᵤⱼ(Θ))

The outer level loss can be denoted as:

[symbol]

_{Van}(u,i,j;Θ*(∧))=−log σ(ŷᵤⱼ(Θ*(∧)−ŷᵤⱼ(Θ*(∧))

Where σ(.) denotes the sigmoid activation function.

Loss computation module 220 performs the operations required to compute the inner level loss and outer level loss. The computed inner level and outer level losses are provided to an update RS parameters module 222 that computes respective gradients that are back-propagated to update the model embeddings Θ and weight generator parameters ∧ as part of gradient descent based training of the RS 200. The model embeddings Θ are updates based on the inner level loss, at time t, and the weight generator parameters ∧ are updated based on the outer level loss, at time t+1. As represented in the above equations, the inner and outer level losses are based on minimizing a weighted difference between the relevance scores ŷᵤᵢ and ŷᵤⱼ that correspond to the user, positive item and negative item identified in a triplet (u, i, j).

Accordingly, during the training phase for RS 200, the system parameters are learned through a 2 stage interactive training process. In particular, inner optimization/model embedding Θ update stage is performed during which the weight generator parameters ∧ are fixed and model embeddings Θ are updated using gradient descent. An outer optimization/weight generator parameters ∧ update stage is then performed, during which the model embeddings Θ are fixed and weight generator parameters ∧ are updated using gradient descent. The inner and outer update stages can be iteratively repeated until convergence is achieved. As noted above, in the case of bilevel optimization the outer optimization constraints must be enforced indirectly. Accordingly, in example embodiments this accomplished by using a proxy function to generate a connection between the gradient on weight generator parameters ∧ with the outer objective. The proxy function is defined below:

\tilde{Θ}^{t+1}:=Θ^{t}−α∇_{Θ}_{^{t}} [symbol] ᵢₙₙₑᵣ(Θ^{t},∧^{t})

The proxy model embeddings \tilde{Θ}^{t+1} are the model embeddings Θ^{t} from the previous training iteration adjusted by the gradient descent value determined by the current training iteration as scaled by a hyperparameter scaling value α. In this regard, the proxy function provides a manual adjustment of the of model embeddings by one step of gradient decent.

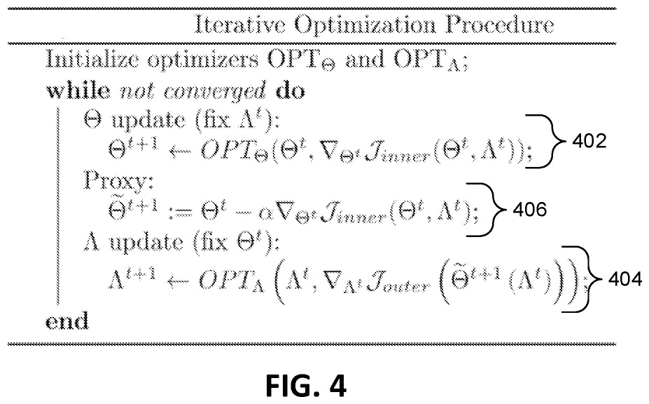

A pseudocode representation of bilevel optimization process for training RS 100 to learn optimized system parameters for the RS 100 is represented in FIG. 4. Reference 402 indicates pseudocode for inner optimization/model embedding Θ update stage, during which the weight generator parameters ∧ are fixed and model embeddings Θ are updated during a first time-step t according to an inner-level objective function. Reference 404 indicates pseudocode for outer optimization/weight generator parameters ∧ update stage, during which the model embeddings Θ are fixed and weight generator parameters ∧ are updated using gradient descent during a subsequent time-step t+1 according to an outer-level objective function. Reference 406 illustrates a proxy function that is used to generate a connection between a gradient and weight generator parameters ∧ for the outer objective.

In summary, identify triplets module 224 uses the user-item interaction dataset (e.g., U-I Interaction matrix 204) to construct a set of BPR training triplets (u, i, j). Triplet weight generator module 228 then generates respective weights wᵤᵢⱼ for each triplet (u, i, j), according to weight generator parameters ∧. Then the weights are multiplied with a BPR loss to form a weighted BPR loss. Moreover, the learned weight parameters W are adaptively generated during end-to-end training of the RS 200, which enables the relative importance of different triplets to be learned. This may mitigate against the problem of implied false positives and false negatives described above and thereby improve one or more of training accuracy, training efficiency and recommendation quality in some RS applications. Among other things, improvement of one or more of training accuracy, training efficiency and recommendation quality can save time and computing resources when compared to known solutions.

The BPR RS methods described above can apply on top of any number of suitable RSs. In example embodiments, the triplet weight generator module 228 and the final embedding module 212 can be implemented using a variety of different ML models. For example, personalized RSs commonly use deep learning/graphic neural network models that are configured to learn user and item embeddings as the ultimate goal. Accordingly, final embedding module 212 could include a GNN model.

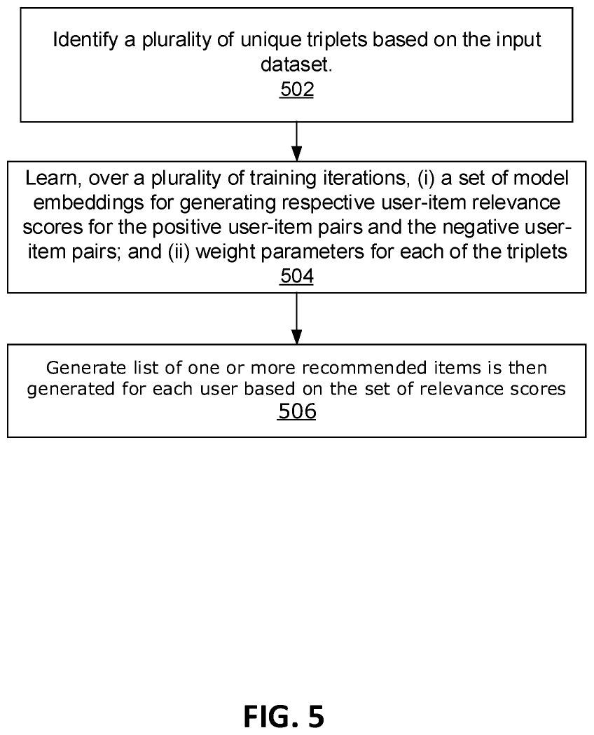

FIG. 5 is flow chart illustrating the operation of RS 200. As noted above, the input dataset to the RS 200 is a U-I interaction matrix that identifies a set of users U, a set of items I, and user-item interaction data about historic interactions between users u in the set of users U and items v in the set of items I. As indicated at 502, RS 200 identifies a plurality of unique triplets based on the input dataset. Each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item. As indicated at 502, the method further includes learning, over a plurality of training iterations, (i) a set of model embeddings for generating respective user-item relevance scores for the positive user-item pairs and the negative user-item pairs; and (ii) weight parameters for each of the triplets, wherein the learning is configured to jointly optimize the model embeddings and the weight parameters to reach a learning objective that is based on weighted difference values determined for the triplets, wherein for each triplet, the difference value is a difference between the user-item relevance score generated for the positive user-item pair thereof and the user-item relevance score generated for the negative user-item pair thereof. As indicated at 506, a list of one or more recommended items is then generated for each user based on a set of user-item relevance scores generated using the learned set of model embeddings.

Processing System

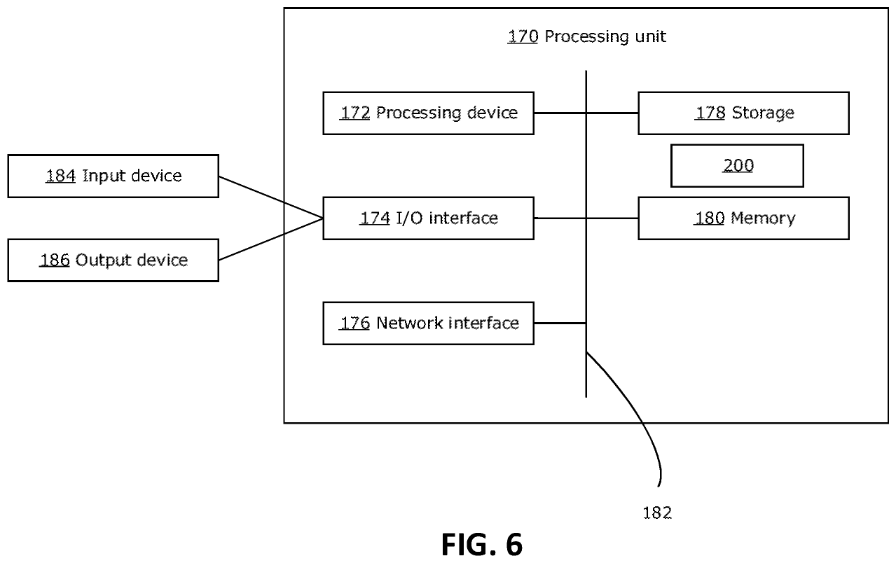

In example embodiment, the modules of RS 200 are computer implemented using one or more physical or virtual computing devices. FIG. 6 is a block diagram of an example processing system 170, which may be used in a physical or virtual computer device to execute machine executable instructions to implement the modules of RS 200. Other processing systems suitable for implementing embodiments described in the present disclosure may be used, which may include components different from those discussed below. Although FIG. 6 shows a single instance of each component, there may be multiple instances of each component in the processing system 170.

The processing system 170 may include a processing device 172 that comprises one or more processing elements, such as a processor, a microprocessor, a general processor unit (GPU), an artificial intelligence processor, a tensor processing unit, a neural processing unit, an application-specific integrated circuit (ASIC), a field-programmable gate array (FPGA), a dedicated logic circuitry, accelerator logic, or combinations thereof. The processing system 170 may also include one or more input/output (I/O) interfaces 174, which may enable interfacing with one or more appropriate input devices 184 and/or output devices 186. The processing system 170 may include one or more network interfaces 176 for wired or wireless communication with a network.

The processing system 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such instructions that configure the processing system 170 to implement the modules of RS 200 and carry out examples described in the present disclosure. The memory(ies) 180 may include other software instructions, such as for implementing an operating system and other applications/functions.

There may be a bus 182 providing communication among components of the processing system 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

In some example embodiments, the RS 200 is implemented as a software-as-service in a cloud computing platform by a cloud computing provider. In example embodiment, the modules of RS 200 are computer implemented in on demand computing system resources of a cloud computing platform.

Although the present disclosure describes methods and processes with steps in a certain order, one or more steps of the methods and processes may be omitted or altered as appropriate. One or more steps may take place in an order other than that in which they are described, as appropriate. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure are incorporated herein by reference.

1. A computer implemented method in a recommendation system for processing an input dataset that identifies a set of users, a set of items, and user-item interaction data, the method comprising:
identifying a plurality of unique triplets based on the input dataset, wherein each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item;
learning, over a plurality of training iterations, (i) a set of model embeddings for generating respective user-item relevance scores for the positive user-item pairs and the negative user-item pairs; and (ii) weight parameters for each of the triplets, wherein the learning is configured to jointly optimize the model embeddings and the weight parameters to reach a learning objective that is based on weighted difference values determined for the triplets, wherein for each triplet, the difference value is a difference between the user-item relevance score generated for the positive user-item pair thereof and the user-item relevance score generated for the negative user-item pair thereof; and
generating a list of one or more recommended items for each user based on a set of user-item relevance scores generated using the learned set of model embeddings.

2. The method of claim 1 wherein, for each triplet, the indication in the user-item interaction data that the second item is less relevant to the user than the first item comprises a first indication that the first item has been observed by the user and a second indication that the second item has not been observed by the user.

3. The method of claim 1 wherein the weight parameters comprise a respective weight value for each triplet, and the learning objective is to maximize a sum of the weighted difference values determined for the triplets, wherein each difference value is weighted by the respective weight value for the triplet that the difference value is determined in respect of.

4. The method of claim 3 wherein learning the set of model embeddings and the weight parameters comprises performing a bilevel optimization process that includes an inner optimization stage for learning the model embeddings based on a lower-level objective function and an outer optimization stage for learning the weight parameters based on an upper level objective function.

5. The method of claim 4 wherein performing the bilevel optimization process comprises commuting proxy embeddings for the model embeddings and using the proxy embeddings during the outer optimization stage.

6. The method of claim 4 wherein:
the inner optimization stage for learning the model embeddings comprises:
(a) generating the respective weight values for each of the triplets based on the weight parameters;
(b) generating a set of final user embeddings and final item embeddings based on the model embeddings, wherein the model embeddings include representative user model vectors for each of the users in the set of users and representative item model vectors for each of the items in the set of items;
(c) generating the respective user-item relevance scores for the positive user-item pairs and the negative user-item pairs based on the final user embeddings and the final item embeddings;
(d) determining the difference values for the triplets based on the generated relevance scores;
(e) determining the sum of the weighted difference values for the triplets comprising: determining, for each triplet, the product of the difference value and the weight value for the triplet; and summing the products;
(f) updating the model embeddings by a model embeddings gradient based on the sum of the weighted difference values;
(g) repeating (b to f) until the model embeddings are optimized with respect to the weight parameters; and
the outer optimization stage for learning the weight parameters comprises:
(h) determining a proxy set of model embeddings;
(i) generating a set of final user embeddings and final item embeddings based on the proxy set of model embeddings;
(j) generating the respective user-item relevance scores for the positive user-item pairs and the negative user-item pairs based on the final user embeddings and the final item embeddings;
(k) determining the difference values for the triplets based on the generated relevance scores;
(l) determining the sum of the weighted difference values for the triplets comprising: determining, for each triplet, the products of the difference value and the weight value for the triplet; and summing the products;
(m) updating the weight parameters by a weight parameter gradient based on the sum of the weighted difference values;
(n) generating an updated set of the weight values for the triplets based on the updated weight parameters;
(o) repeating (l to n) until the weight parameters are optimized with respect to the proxy set of model embeddings.

7. The method of claim 1 comprising generating the respective relevance scores during each of the training iterations by:
generating, based on the user-item interaction data, a user-user similarity dataset that indicates user-user similarity scores for pairs of users in the set of users;
generating, based on the user-item interaction data, an item-item similarity dataset that indicates item-item similarity scores for pairs of items in the set of items;
determining final user embeddings based on the user-user similarity dataset and a set of personalized user embeddings included in the model embeddings;
determining final item embeddings based on the item-item similarity dataset and a set of personalized item embeddings included in the model embeddings;
determining the user-item relevance scores based on the final user embeddings and the final item embeddings.

8. The method of claim 1 wherein the set of model embeddings configure a first artificial network and the weight parameters configure a second artificial neural network.

9. A recommendation system for processing an input dataset that identifies a set of users, a set of items, and user-item interaction data about historic interactions between users in the set of users and items in the set of items, the recommendation system comprising:
a processing device;
a non-transient storage coupled to the processing device and storing software instructions that when executed by the processing device configure the recommendation system to:
identify a plurality of unique triplets based on the input dataset, wherein each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item;
learn, over a plurality of training iterations, (i) a set of model embeddings for generating respective user-item relevance scores for the positive user-item pairs and the negative user-item pairs; and (ii) weight parameters for each of the triplets, wherein the model embeddings and the weight parameters are jointly learned to reach a learning objective that is based on weighted difference values determined for the triplets, wherein for each triplet, the difference value is a difference between the user-item relevance score generated for the positive user-item pair thereof and the user-item relevance score generated for the negative user-item pair thereof; and
generate a list of one or more recommended items for each user based on a set of user-item relevance scores generated using the learned set of model embeddings.

10. The recommendation system of claim 9 wherein, for each triplet, the indication in the user-item interaction data that the second item is less relevant to the user than the first item comprises a first indication that the first item has been observed by the user and a second indication that the second item has not been observed by the user.

11. The recommendation system of claim 9 wherein the weight parameters comprise a respective weight value for each triplet, and the learning objective is to maximize a sum of the weighted difference values determined for the triplets, wherein each difference value is weighted by the respective weight value for the triplet that the difference value is determined in respect of.

12. The recommendation system of claim 9 wherein the recommendation system is configured to learning the set of model embeddings and the weight parameters through performing a bilevel optimization process that includes an inner optimization stage for learning the model embeddings based on a lower-level objective function and an outer optimization stage for learning the weight parameters based on an upper level objective function.

13. The recommendation system of claim 12 wherein performing the bilevel optimization process comprises computing proxy embeddings for the model embeddings and using the proxy embeddings during the outer optimization stage.

14. The recommendation system of claim 12 wherein:
the inner optimization stage for learning the model embeddings comprises:
(a) generating the respective weight values for each of the triplets based on the weight parameters;
(b) generating a set of final user embeddings and final item embeddings based on the model embeddings, wherein the model embeddings include representative user model vectors for each of the users in the set of users and representative item model vectors for each of the items in the set of items;
(c) generating the respective user-item relevance scores for the positive user-item pairs and the negative user-item pairs based on the final user embeddings and the final item embeddings;
(d) determining the difference values for the triplets based on the generated relevance scores;
(e) determining the sum of the weighted difference values for the triplets comprising: determining, for each triplet, the product of the difference value and the weight value for the triplet; and summing the products;
(f) updating the model embeddings by a model embeddings gradient based on the sum of the weighted difference values;
(g) repeating (b to f) until the model embeddings are optimized with respect to the weight parameters; and
the outer optimization stage for learning the weight parameters comprises:
(h) determining a proxy set of model embeddings;
(i) generating a set of final user embeddings and final item embeddings based on the proxy set of model embeddings;
(j) generating the respective user-item relevance scores for the positive user-item pairs and the negative user-item pairs based on the final user embeddings and the final item embeddings;
(k) determining the difference values for the triplets based on the generated relevance scores;
(l) determining the sum of the weighted difference values for the triplets comprising: determining, for each triplet, the products of the difference value and the weight value for the triplet; and summing the products;
(m) updating the weight parameters by a weight parameter gradient based on the sum of the weighted difference values;
(n) generating an updated set of the weight values for the triplets based on the updated weight parameters;
(o) repeating (l to n) until the weight parameters are optimized with respect to the proxy set of model embeddings.

15. The recommendation system of claim 9 wherein the recommendation system is configured to generate the respective relevance scores during each of the training iterations by:
generating, based on the user-item interaction data, a user-user similarity dataset that indicates user-user similarity scores for pairs of users in the set of users;
generating, based on the user-item interaction data, an item-item similarity dataset that indicates item-item similarity scores for pairs of items in the set of items;
determining final user embeddings based on the user-user similarity dataset and a set of personalized user embeddings included in the model embeddings;
determining final item embeddings based on the item-item similarity dataset and a set of personalized item embeddings included in the model embeddings;
determining the user-item relevance scores based on the final user embeddings and the final item embeddings.

16. The recommendation system of claim 12 wherein set of model embeddings configure a first artificial network that is implemented by the recommendation system and the weight parameters configure a second artificial neural network that is implemented by the recommendation system.

17. A non-volatile computer readable medium storing software instructions that, when executed by a processing device, cause the processing device to:
receive an input dataset that identifies a set of users, a set of items, and user-item interaction data about historic interactions between users in the set of users and items in the set of items;
identify a plurality of unique triplets based on the input dataset, wherein each triplet includes: (i) a positive user-item pair that includes a user from the set of users and a first item from the set of items; and (ii) a negative user-item pair that includes the same user as the positive user-item pair and a second item from the set of items, based on an indication in the user-item interaction data that the second item is less relevant to the user than the first item;
learn, over a plurality of training iterations, (i) a set of model embeddings for generating respective user-item relevance scores for the positive user-item pairs and the negative user-item pairs; and (ii) weight parameters for each of the triplets, wherein the model embeddings and the weight parameters are jointly learned to reach a learning objective that is based on weighted difference values determined for the triplets, wherein for each triplet, the difference value is a difference between the user-item relevance score generated for the positive user-item pair thereof and the user-item relevance score generated for the negative user-item pair thereof; and
generate a list of one or more recommended items for each user based on a set of user-item relevance scores generated using the learned set of model embeddings.

18. The non-volatile computer readable medium of claim 17 wherein, for each triplet, the indication in the user-item interaction data that the second item is less relevant to the user than the first item comprises a first indication that the first item has been observed by the user and a second indication that the second item has not been observed by the user.

19. The non-volatile computer readable medium of claim 17 wherein the weight parameters comprise a respective weight value for each triplet, and the learning objective is to maximize a sum of the weighted difference values determined for the triplets, wherein each difference value is weighted by the respective weight value for the triplet that the difference value is determined in respect of.

20. The non-volatile computer readable medium of claim 19 wherein the software instructions that cause the processing device to learn the set of model embeddings and the weight parameters through performing a bilevel optimization process that includes an inner optimization stage for learning the model embeddings based on a lower-level objective function and an outer optimization stage for learning the weight parameters based on an upper level objective function.
